(19) United States
(12) Patent Application Publication
(10) Pub. No.: US 2026/0198524 A1
(43) Pub. Date: Jul. 16, 2026

(54) MEAT ANALOGUE COMPRISING FIBROUS TEXTURIZED VEGAN PROTEIN PIECES AND PROCESS TO PRODUCE THE SAME

(71) Applicant: CONOPCO, INC., D/B/A UNILEVER, Hoboken, NJ (US)

(72) Inventors: Paul BOM, Wageningen (NL); Joep Johan DONDERS, Wageningen (NL); Marco SANTAGIULIANA, Wageningen (NL)

(73) Assignee: CONOPCO, INC., D/B/A UNILEVER, Hoboken, NJ (US)

(21) Appl. No.: 19/134,805

(22) PCT Filed: Dec. 21, 2023
(86) PCT No.: PCT/EP2023/087475

§ 371 Date: Jun. 2, 2025

(30) Foreign Application Priority Data
Dec. 23, 2022 (EP) 22216371.9

(51) Int. Cl. A23J 3/22; A23J 3/18; A23L 23/00; A23L 29/256

(52) U.S. Cl. CPC A23J 3/227; A23J 3/18; A23L 23/00; A23L 29/256

(57) ABSTRACT

An improved meat analogue and process for producing the same.

### TECHNICAL FIELD OF THE INVENTION

The present invention relates to meat analogues, especially meat analogues that closely resemble stewed meat in texture and appearance. The invention also provides a process of preparing such meat analogues.

### BACKGROUND OF THE INVENTION

Meat analogues are increasing in popularity. Most popular are hamburger or sausage type of meat analogues. In general, these can be made by mixing plant protein particles with water flavouring, coloring, oil to form a meat analogue dough. The dough can be formed into hamburgers or sausages. It can be shaped and breaded to look like schnitzels.

The plant protein particles mostly used in the production of meat analogues are texturized vegetable protein pieces. Textured vegetable protein pieces are produced by cooking and kneading a mixture of plant protein (e.g. soy protein isolate) and water in an extruder, and cutting the extrudate into pieces. The use of textured vegetable protein to make meat analogues has the advantage that it is cost-effective. A drawback of textured vegetable protein is the limited variation in mouthfeel that can be achieved when used in meat analogues. Textured vegetable protein provides a mouthfeel similar to real minced meat which makes it very suitable for use in burgers and sausages.

However, so far it has proved impossible to produce good analogues of stewed meat using textured vegetable protein.

Stewing is a technique that is used to render cuts of tough meat tender and juicy, by cooking these cuts in aqueous liquid for a considerable period of time. Meat cut from the shoulder of a cow is quite tenacious due to the high amount of collagen. When stewed long enough the collagen is softened, creating the typical mouthfeel of stewed meat: a combination of firmness, softness and chewiness. Also the appearance of a meat cut changes considerably during stewing. A typical feature of stewed meat is its loose fibrous structure.

### Additional Information

U.S. Pat. No. 4,238,515 describes a physical form of gluten containing an inert food material bound within its matrix, having a net-like fibrous structure which fibers have a diameter smaller than 2 mm diameter, possessing self-binding properties, obtained by the steps comprising:
(a) agitating a mixture consisting essentially of hydrated vital wheat gluten and a reducing agent at a temperature below 70′ C. to form a softened, net-like fibrous structure, and
(b) incorporating during said agitation the solid inert food material having particles size below 5 cm diameter in an amount sufficient to obtain a ratio of gluten to inert food material of from about 1:0:1 to 1:10.

U.S. Pat. No. 4,938,976 describes a method for the manufacture of a meat-like or fish-like product comprising incorporating a coloring agent, a spice and a fat into a gluten product obtained by:
(a) agitating wheat gluten with ascorbic acid in the presence of a solution of an edible acid at a pH in the range of between 5.0 and 7.0 and at a temperature below 70° C. to produce a relaxed gluten in the form of viscous liquid-like structure; and
(b) generating a stable fibrous structure by incorporating a textured vegetable protein in said relaxed gluten.

GB-B 1,548,971 describes a process for making a meat analog product comprising the steps of:
(a) extruding at a temperature of 120-200° C. and a pressure of at least 100 p.s.i.g., a first mixture having a protein concentration of at least 25% by weight, a water content of from 20% to 50% by weight, a non-protein solids content of from 0% to 55% by weight, and a pH of from 5.0 to 8.0;
(b) cooling the extrudate of step (a) thereby forming a non-plastic extrudate,
(c) cutting the non-plastic extrudate of step (b) thereby providing irregularly shaped, discrete pieces; and
(d) heat-setting a second mixture comprising from 10% to 85% by weight of the pieces of step (c), from 0% to 70% by weight of a fat, from 1% to 30% by weight of a hydratable, substantially undenatured vegetable protein-containing material having a protein concentration of at least 70% by weight and from 5% to 80% by weight of water.

EP-A 0 010 798 describes a process for producing a foodstuff with a fibrous structure which comprises:
a) producing a mixture mainly consisting of (i) 50-80 wt. % of a vegetable protein-containing material having a protein content of at least 25%, (ii) 20-50 wt. % water, (iii) 0.5-8 wt. % lipids and (iv) an effective proportion of an edible agent imparting toughness to the protein material;
b) extruding said mixture while ensuring that an extrudate is obtained having a moisture content of at least 30 wt. %;
c) shredding said extrudate;
d) incorporating the shreds in a protein binder; and
e) heat-setting the mixture consisting of binder and shreds.

### SUMMARY OF THE INVENTION

The inventors have designed a meat analogue that closely resembles stewed meat. The inventors have unexpectedly discovered that a meat analogue having a texture and appearance that strongly resembles that of stewed meat can be obtained by employing a carefully balanced combination of elongated pieces, gluten, fat and water.

1. The present invention also provides s a process of preparing a meat analogue comprising the steps of
a) providing hydrated pieces of TVP, at least 60 wt. % of said hydrated pieces of TVP being elongated pieces, preferably having a maximum Feret diameter of 20-80 mm and preferably a Circularity of less than 0.35;
b) mixing 25-45 parts by weight of said hydrated pieces of TVP with 20-40 parts by weight of water, 13 to 35 parts by weight of vital gluten and 0 to 18 parts by weight of fat to form a meat analogue dough;
c) heating the meat analogue dough to a temperature of at least 70° C. to denature the vital gluten and to coagulate the meat analogue dough;
d) cutting the coagulated meat analogue dough into chunks of meat analogue of at least 5 grams.

2. The present invention also provides a process of preparing a meat analogue comprising the steps of
a) providing hydrated pieces of TVP, at least 60 wt. % of said hydrated pieces of TVP being elongated pieces, having a maximum Feret diameter of 20-80 mm and a Circularity of less than 0.35;
b) mixing 25-45 parts by weight of said hydrated pieces of TVP with 20-40 parts by weight of water, 13 to 35 parts by weight of vital gluten and 0 to 18 parts by weight of fat to form a meat analogue dough;
c) heating the meat analogue dough to a temperature of at least 70° C. to denature the vital gluten and to coagulate the meat analogue dough;
d) cutting the coagulated meat analogue dough into chunks of meat analogue of at least 5 grams.

3. The present invention further provides a method of preparing a food product, said method comprising:
combining a meat analogue of the present invention with a gravy or a sauce in a container; and
sealing the container.

4. The present invention provides to a meat analogue comprising, calculated by weight of dry matter:
(a) 15-45 wt. %, preferably 15-35 wt. % of pieces of texturized vegan protein (TVP);
(b) 20-55 wt. % of gluten;
(c) 0-40 wt. % of fat;
wherein the combination of components (a), (b) and (c) constitutes at least 65 wt. % of the dry matter that is contained in the meat analogue; and
wherein at least 60 wt. % of the pieces of TVP in the meat analogue are elongated pieces, preferably having a maximum Feret diameter of 20-80 mm and preferably a Circularity of less than 0.35.

5. The present invention also provides a meat analogue comprising, calculated by weight of dry matter:
(a) 15-45 wt. %, preferably 15-35 wt. % of pieces of texturized vegan protein (TVP);
(b) 20-55 wt. % of gluten;
(c) 0-40 wt. % of fat;
wherein the combination of components (a), (b) and (c) constitutes at least 65 wt. % of the dry matter that is contained in the meat analogue; and
wherein at least 60 wt. % of the pieces of TVP in the meat analogue are elongated pieces, having a maximum Feret diameter of 20-80 mm and a Circularity of less than 0.35.

6. The present invention further provides a process according to 1 or a meat analogue according to 4 wherein said elongated pieces have a maximum Feret diameter of 20-80 mm.

7. The present invention further provides a process or a meat analogue according 1 to 5 wherein said elongated pieces have a maximum Feret diameter of 25-60 mm.

8. The present invention further provides a process or a meat analogue according to 1 to 7 wherein said elongated pieces have a Circularity of less than 0.35.

9. The present invention further provides a process or a meat analogue according to 1 to 7 wherein said elongated pieces have a Circularity of less than 0.32.

10. The present invention further provides a process or a meat analogue according to 1 to 7 wherein said elongated pieces have a Circularity of less than 0.30.

11. The present invention further provides a process or a meat analogue according to 1 to 7 wherein said elongated pieces have a Circularity of less than 0.25.

12 The present invention further provides a process or a meat analogue according to 1 to 7 wherein said elongated pieces have a Circularity of less than 0.20.

13. The present invention further provides a process or a meat analogue according to 1 to 7 wherein said elongated pieces have a Circularity of 0.08-0.20.

14. The present invention further provides a process or a meat analogue according to 1 to 13 wherein the meat analogue comprises 5 to 25 wt. % fat calculated by weight of dry matter of the meat analogue.

15. The present invention further provides a process or a meat analogue according to 1 to 13 wherein the meat analogue comprises 8 to 15 wt. % fat calculated by weight of dry matter of the meat analogue.

16. The present invention further provides a process or a meat analogue according to 1 to 15 wherein the elongated pieces of TVP in the meat analogue are not aligned.

17. The present invention further provides a process according to 1 to 15, wherein in step b) the amount of fat mixed is such that the meat analogue comprises 5 to 25 wt. % fat calculated by weight of dry matter of the meat analogue.

18. The present invention further provides a process according to 1 to 15, wherein in step b) the amount of fat mixed is such that the meat analogue comprises 8 to 15 wt. % fat calculated by weight of dry matter of the meat analogue.

19. The present invention further provides a process according to 1 to 18, wherein in step b) carrageenan is mixed such that the meat analogue comprises 0.1 to 2 wt. % of carrageenan by weight of the total meat analogue, preferably kappa carrageenan.

20. The present invention further provides a process according to 1 to 19 wherein the cut meat analogue is combined with gravy or a sauce in a container followed by sealing of the container.

21. The present invention further provides a meat analogue according to 1 to 16 wherein the meat analogue comprises 0.1-2 wt. %, preferably 0.2-1 wt. % of a gelling polysaccharide by weight of the total meat analogue.

22. The present invention further provides a meat analogue according to 1 to 16 wherein the meat analogue comprises 0.1-2 wt. %, preferably 0.2-1 wt. % of carrageenan by weight of the total meat analogue.

23. The present invention further provides a meat analogue according to 1 to 16 wherein the meat analogue comprises 0.1-2 wt. %, preferably 0.2-1 wt. % of kappa carrageenan by weight of the total meat analogue.

24. The present invention further provides a meat analogue according to 1 to 23 wherein the meat analogue is a stewed meat analogue.

25. The present invention further provides a meat analogue according to 1 to 24 wherein the meat analogue comprises, calculated by weight of dry matter, 15-30 wt. % of pieces of TVP.

26. The present invention further provides a meat analogue according to 1 to 25 wherein the meat analogue comprises, calculated by weight of dry matter, 22-50 wt. % of gluten.

### DETAILED DESCRIPTION OF THE INVENTION

Any feature belonging to one particular aspect of the present invention may also be utilised in connection with other aspects of the invention.

Ratios mentioned herein are based on weight/weight, unless indicated otherwise. Similarly, all percentages are percentages by weight (w/w) of the total meat analogue (wet) unless otherwise indicated.

Numerical ranges expressed in the format “from x to y” are understood to include x and y.

When for a specific feature multiple preferred ranges are described in the format “from x to y”, it should be understood that all ranges combining the different endpoints are also contemplated.

If for a particular component a range of 0% to y % or less than y % is recited, said ingredient may be absent.

The terms “a” and “an” and “the” and similar referents as used herein refer to both the singular and the plural, unless otherwise indicated herein or clearly contradicted by context.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Concentrations expressed by weight of dry matter as mentioned herein refer to the amount of dry ingredient that is present in a composition as a percentage (w/w) of the total amount of dry matter that is contained in the same composition.

The term “meat analogue” as used herein refers to an edible product that does not contain animal meat.

The term “texturized vegan protein” or “TVP” as used herein refers to proteinaceous chunks which are produced by cooking an aqueous mixture of water, vegan protein isolate (including vegan protein concentrates) and optionally other ingredients in an extruder cooker and extruding the mixture. Examples of plant proteins that can be used in the preparation of TVP are soy protein, pea protein, sunflower protein, mung bean protein and mycoprotein.

The term “vegan” as used herein in relation to a product or an ingredient refers to a product or an ingredient that has not been derived from animals. Meat, eggs and dairy products are examples of products that are not vegan.

The term “fat” as used herein refers to a glyceride component selected from triglycerides, diglycerides, monoglycerides, phosphoglycerides and combinations thereof.

The term “vital gluten” as used herein refers to gluten that is at least partially undenatured and that is capable of heat-induced coagulation.

The term “Feret diameter” as used herein refers to the distance between two parallel tangents to the contour of a particle at an arbitrary angle. The maximum Feret diameter represents the maximum distance between two parallel tangents to the contour of a particle. The minimum Feret diameter represents the minimum distance between two parallel tangents to the contour of a particle. The maximum and minimum Feret diameter of pieces of TVP that are present in a meat analogue or a TVP product may suitably be determined by separating the pieces of TVP so that they do not overlap, and by recording the shape of the individual pieces in two-dimensional format. These measurements may suitably be carried out with the use of commercially available image processing software, such as ImageJ.

The Circularity of a TVP piece is determined from the shape of the TVP piece that has been recorded in two-dimensional format. The Circularity of an individual object is calculated on the basis of the following equation:

Circularity=4π×Area/Perimeter²

For a perfect sphere, Circularity equals 1. For objects with another shape, Circularity is in the range of 0 to 1. The Circularity can be obtained by any suitable means including commercially available image processing software, such as ImageJ.

The aspect ratio of a piece of TVP equals the maximum Feret diameter of a piece of TVP divided by the minimum Feret diameter of the same piece of TVP, as determined from a two-dimensional image of said piece of TVP.

The recited gluten content of the meat analogue of the present invention does not include any gluten that may be contained in the pieces of TVP. Likewise, the recited fat content does not include any fat that may be contained in the pieces of TVP.

### Meat Analogue

The meat analogue according to the present invention preferably is a vegetarian product, i.e. it does not contain meat or by-products of animal slaughter. Even more preferably, the meat analogue is a vegan product, i.e., it does not contain any animal products (e.g. meat, eggs, dairy products).

The pieces of TVP in the meat analogue of the present invention are typically bound together by a coagulated aqueous phase comprising gluten and fat.

The pieces of TVP and gluten are preferably contained in the meat analogue of the present invention in a dry weight ratio (w/w) of 0.3 to 2, preferably of 0.3 to 1.1, more preferably in a dry weight ratio (w/w) of 0.35 to 0.9. Surprisingly, it was found that stew meat analogues in these specific ranges were preferred in blind testing by the panellists regarding visual appearance and a number of sensory attributes including, fibrosity, firmness, chewiness.

Preferably, besides pieces of TVP, gluten, fat and water, the meat analogue of the present invention also contains plant protein selected from soy protein, pulse protein, potato protein and combinations thereof. More preferably, the meat analogue comprises, calculated by weight of dry matter, 4-15 wt. %, even more preferably 6-21 wt. % of plant protein selected from soy protein, pulse protein, potato protein and combinations thereof. These percentages of plant protein do not include the plant protein that is present in the pieces of TVP.

The total water content of the meat analogue is preferably in the range of 48-65 wt. %, more preferably in the range of 50-58 wt. %.

The meat analogue preferably has a dry matter content of 35-52 wt. %, more preferably of 42-50 wt. %.

The combination of pieces of TVP, gluten and fat preferably constitutes 70-90 wt. %, more preferably 75-80 wt. % of the dry matter that is contained in the meat analogue.

Methylcellulose is a compound that is derived from cellulose and that does not occur naturally. Methylcellulose is widely used in meat analogues. However, many consumers are opposed to the use of methylcellulose in food products. The present invention offers the advantage that a good quality meat analogue can be prepared with using methylcellulose. Accordingly, in a preferred embodiment, the meat analogue does not contain methylcellulose.

The meat analogue of the present invention may be provided in different shapes. Preferably, the meat analogue is provided in a form that is typical of stewed meat products, e.g., irregularly shaped chunks or slabs, as opposed to regularly shaped meat products such as patties, balls and sausages.

### Pieces of TVP

The meat analogue preferably comprises, calculated by weight of dry matter, 16-40 wt. %, more preferably 22-39 wt. % of pieces of TVP.

The pieces of TVP in the meat analogue of the present invention typically contain, calculated by weight of dry matter, 50-90 wt. %, more preferably 65-88 wt. % and most preferably 70-86 wt. % of plant protein. The plant protein preferably is selected from legume protein, cereal protein, oilseed protein and combinations thereof. More preferably, the plant protein is selected from legume protein, cereal protein and combinations thereof. Examples of legume proteins that may be used include soy protein, pea protein, lupin protein, mung bean protein, faba bean protein, lentil protein, chickpea protein and combinations thereof. Gluten is an example of cereal protein that may be contained in the pieces of TVP.

According to a particularly preferred embodiment, at least 50 wt. %, more preferably at least 80 wt. % and most preferably at least 90 wt. % of the plant protein that is present in the pieces of TVP is soy protein.

The pieces of TVP preferably have a water content of 40-90 wt. %, more preferably of 50-85 wt. % and most preferably of 55-75 wt. %.

The fat content of the pieces of TVP, calculated by weight of dry matter, preferably is in the range of 0-10 wt. %, more preferably in the range of 0-6 wt. % and most preferably in the range of 0-4 wt. %.

The pieces of TVP present in the meat analogue, calculated by weight of dry matter, preferably contain 0-15 wt. %, more preferably 0.5-12 wt. % and most preferably 1-10 wt. % of dietary fiber.

According to a preferred embodiment, at least 80 wt. % of the pieces of TVP in the meat analogue have a maximum Feret diameter of 20-80 mm, more preferably a maximum Feret diameter of 25-60 mm.

In a preferred embodiment, at least 60 wt. % of the pieces of TVP in the meat analogue are elongated pieces having a maximum Feret diameter of 20-80 mm and a Circularity of less than 0.32, more preferably a Circularity of less than 0.30, even more preferably of less than 0.25 and most preferably a Circularity in the range of 0.08-0.20.

In a particularly preferred embodiment, at least 80 wt. % of the pieces of TVP in the meat analogue are elongated pieces having a maximum Feret diameter of 20-80 mm and a Circularity of less than 0.32, more preferably a Circularity of less than 0.30, even more preferably of less than 0.25 and most preferably a Circularity in the range of 0.08-0.20.

The pieces of TVP preferably have an aspect ratio of at least 4:1, more preferably an aspect ratio of at least 7:1.

The elongated TVP pieces that are employed in accordance with the present invention preferably are shredded TVP pieces. Shredded TVP pieces showing fraying along the lengthy sidewalls are particularly preferred.

According to another particularly preferred embodiment, the elongated pieces in the meat analogue are not aligned, i.e., the elongated pieces are not parallel aligned along their longest axis.

If it is desirable, the elongated TVP pieces may be recovered from the meat analogue using a sieve by gently removing the binder phase comprising gluten manually under a running hot water tap.

### Gluten

The gluten content of the meat analogue (excluding any gluten that is contained in the TVP), calculated by weight of dry matter, is preferably in the range of 22-50 wt. %, most preferably in the range of 25-45 wt. %.

Preferably, the gluten employed in the meat analogue is wheat gluten.

According to a particularly preferred embodiment, the gluten that is employed in the preparation of the meat analogue is vital wheat gluten.

The gluten that is employed in the preparation of the meat analogue is preferably in powder form.

According to a particularly preferred embodiment, the gluten that is present in the meat analogue is coagulated.

### Fat

The meat analogue preferably comprises, calculated by weight of dry matter, 5-25 wt. %, more preferably 8-15 wt. % of fat (excluding any fat that is contained in the TVP).

The fat that is employed in the meat analogue preferably comprises an oil that is liquid at 20° C.

Examples of liquid oils that may suitably be used include vegetable oils and algal oils. Examples of suitable vegetable oils are sunflower oil, rapeseed oil, corn oil, soybean oil, safflower oil, flaxseed oil, rice bran oil, cottonseed oil, olive oil and canola oil.

Preferably the fat in the meat analogue is substantially free from higher melting vegetable fats selected from palm oil, coconut oil, palm kernel oil and mixtures thereof.

Preferably, the fat in the meat analogue comprises less than 30 wt. % of saturated fatty acid (SAFA), more preferably less than 18 wt. % of SAFA, calculated by weight of the total amount of fatty acids.

### Other Ingredients

The meat analogue of the present invention preferably comprises additional ingredients besides the ones discussed above. Examples of such addition ingredients include gelling agents, thickeners, emulsifiers, acidulants, preservatives, colouring, flavouring, dietary fibers, vitamins and minerals.

### Gelling Agent

According to a particularly preferred embodiment, the meat analogue comprises 0.1-2 wt. %, more preferably 0.2-1 wt. % of a gelling polysaccharide by weight of the total meat analogue. Examples of gelling polysaccharides that may be employed include carrageenan, alginate, konjac gum and combinations thereof. Most preferably, the gelling polysaccharide that is employed is carrageenan (e.g. kappa-carrageenan or iota-carrageenan).

The meat analogue of the present invention preferably comprises colouring and flavouring.

### Flavouring

The meat analogue according to the invention preferably comprises flavouring, more preferably 0.05 to 6 wt. %, most preferably 0.1-4 wt. % of flavouring. The flavouring may suitably comprise yeast extract, hydrolysed vegetable protein, aroma compounds and combinations thereof.

Preferably, the flavour employed in the meat analogue contains at least 0.05 wt. %, more preferably 0.1-3 wt. % of yeast extract, hydrolysed vegetable protein or a combination thereof.

### Packaging

The meat analogue is preferably packaged. Preferably, it is packaged under a modified atmosphere. Preferably, the modified atmosphere has an oxygen content of less than 10 vol %, more preferably of less than 5%.

### Process

The present invention also provides a process of preparing a meat analogue comprising the step of
a) providing hydrated pieces of TVP, at least 60 wt. % of said hydrated pieces of TVP being elongated pieces having a maximum Feret diameter of 20-80 mm and a Circularity of less than 0.35;
b) mixing 25-50 parts by weight of said hydrated pieces of TVP with 20-40 parts by weight of water, 12-26 parts by weight of vital gluten and 0-18 parts by weight of fat to form a meat analogue dough;
c) heating the meat analogue dough to a temperature of at least 70° C. to denature the vital gluten and to coagulate the meat analogue dough;
d) cutting the coagulated meat analogue dough into chunks of meat analogue of at least 5 grams.

The hydrated pieces of TVP that are employed in the present process preferably contain, calculated by weight of dry matter, 50-90 wt. %, more preferably 65-88 wt. % and most preferably 70-86 wt. % of plant protein. The plant protein preferably is selected from legume protein, cereal protein, oilseed protein and combinations thereof. More preferably, the plant protein is selected from legume protein, cereal protein and combinations thereof. Examples of legume protein that may suitably be employed are soy protein, pea protein, lupin protein, mung bean protein, faba bean protein, lentil protein, chickpea protein and combinations thereof. Gluten is an example of cereal protein that may be contained in the hydrated pieces of TVP.

According to a particularly preferred embodiment, at least 50 wt. %, more preferably at least 80 wt. % and most preferably at least 90 wt. % of the plant protein that is present in the hydrated pieces of TVP is soy protein.

The hydrated pieces of TVP preferably have a water content of 40-90 wt. %, more preferably of 50-85 wt. % and most preferably of 55-75 wt. %.

The fat content of the hydrated pieces of TVP preferably is in the range of 0-10 wt. %, more preferably in the range of 0-6 wt. % and most preferably in the range of 0-4 wt. %.

The hydrated pieces of TVP preferably contain, calculated by weight of dry matter, 0-15 wt. %, more preferably 1-12 wt. % and most preferably 3-10 wt. % of dietary fiber.

According to a preferred embodiment, at least 30 wt. %, preferably at least 60 wt. %, most preferably at least 80 wt. % of the hydrated pieces of TVP that are employed in the present process are elongated pieces having a maximum Feret diameter of 20-80 mm, more preferably a maximum Feret diameter of 25-60 mm.

According to a preferred embodiment, at least 30 wt. %, preferably at least 60 wt. %, most preferably at least 80 wt. % of the hydrated pieces of TVP that are employed in the present process are elongated pieces having a Circularity of less than 0.32, more preferably a Circularity of less than 0.30, and most preferably a Circularity of less than 0.30, even more preferably of less than 0.25 and most preferably a Circularity in the range of 0.08-0.20.

In a preferred embodiment, at least 60 wt. % of the hydrated pieces of TVP are elongated pieces having a maximum Feret diameter of 20-80 mm and a Circularity of less than 0.32, more preferably a Circularity of less than 0.30, and most preferably a Circularity of less than 0.30, even more preferably of less than 0.25 and most preferably a Circularity in the range of 0.08-0.20.

In a particularly preferred embodiment, at least 80 wt. % of the hydrated pieces of TVP are elongated pieces having a maximum Feret diameter of 20-80 mm and a Circularity of less than 0.32, more preferably a Circularity of less than 0.30, even more preferably of less than 0.25 and most preferably a Circularity in the range of 0.08-0.20.

The hydrated pieces of TVP preferably have an aspect ratio of at least 4:1, more preferably an aspect ratio of at least 7:1.

Step b) of the process preferably comprises mixing 28-40 parts by weight of the hydrated pieces of TVP with 23-36 parts by weight of water, 15-24 parts by weight of vital gluten and 3-15 parts by weight of fat.

Preferably, step b) of the present process comprising mixing in 2-12 parts by weight, more preferably 3-9 parts by weight of plant protein isolate having a protein content of at least 60 wt. %. Preferably, the plant protein isolate is an isolate obtained from soybeans, pulses, potato or a combination thereof.

According to a particularly preferred embodiment of the present process, the hydrated pieces of TVP are mixed with water and fat before gluten is added.

In the present process, the meat analogue dough is preferably heated to a temperature of at least 80° C. for at least 5 minutes, more preferably for at least 10 minutes and most preferably for 12-20 minutes.

According to a particularly preferred embodiment, the meat analogue dough is heated to a temperature of 80-90° C. for at least 5 minutes, more preferably for at least 10 minutes and most preferably for 12-20 minutes.

The coagulated meat analogue dough is preferably cut into chunks of at least 5 grams, more preferably into chunks of 8 to 15 grams.

After the cutting, the chunks of meat analogue may suitably be subjected to further process steps such as, for instance, marinating.

According to a particularly preferred embodiment, the process of the present invention produces a meat analogue as specified herein before.

The invention also relates to a meat analogue that is obtained by a process as specified herein before.

Yet another aspect of the invention relates to a method of preparing a food product, said method comprising:
combining a meat analogue according to the present invention with a gravy or a sauce in a container; and
sealing the container.

In one preferred embodiment, the meat analogue is combined with the gravy or sauce in the form of chunks having an individual weight of 5 to 18 grams, more preferably of 8 to 15 grams.

In another preferred embodiment, the meat analogue is combined with gravy or sauce in the form of a slab having a weight of 60 to 180 grams, more preferably of 80 to 140 grams.

The invention is further illustrated by the following non-limiting examples.

### EXAMPLES

### Example 1

A meat analogue according to the invention was prepared on the basis of the recipe that is shown in Table 1.

TABLE 1

| | Wt. % |
|---|---|
| Hydrated TVP pieces ¹ | 54.90 |
| Soy protein isolate ² | 4.50 |
| Carrageenan ³ | 0.40 |
| Water | 19.45 |
| Sunflower oil | 6.00 |
| Vital wheat gluten ⁴ | 11.00 |
| Spirit vinegar (20%) | 0.7 |
| Spices | 0.45 |
| Flavouring & colouring | 2.60 |

¹ S-Fibertex 2265, ex Gushen Biotechnology Group
² Supro EX37 HG-IP Du Pont
³ Welco gelform 1263
⁴ Vital Wheat Gluten (200) ADM

Ingredients for examples were sourced from the EU, the USA and China.

The meat analogues were prepared by first hydrating the TVP. Next, the hydrated TVP pieces were shredded in batches of 250 grams in a Stephan bowl chopper (model UMC5) for 1 minute at 1500 RPM with blunt knives. These settings are used for 250 grams of hydrated TVP chunks.

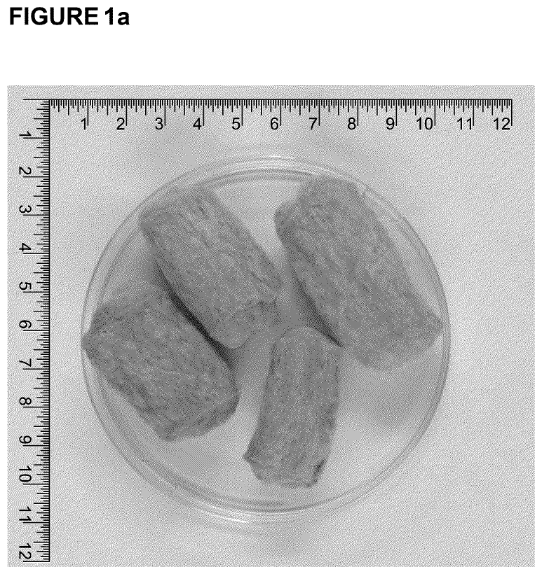

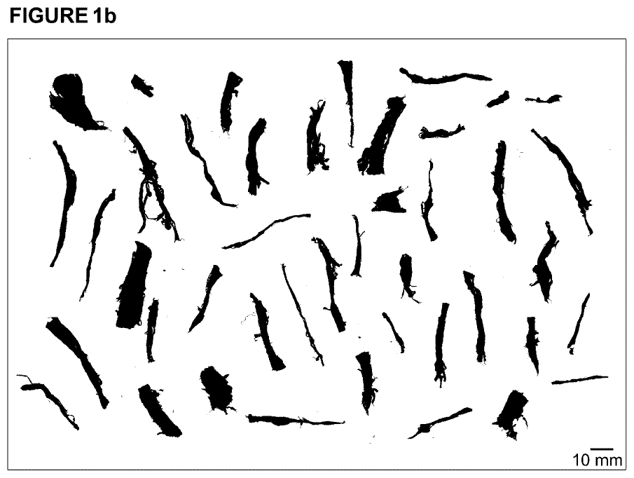

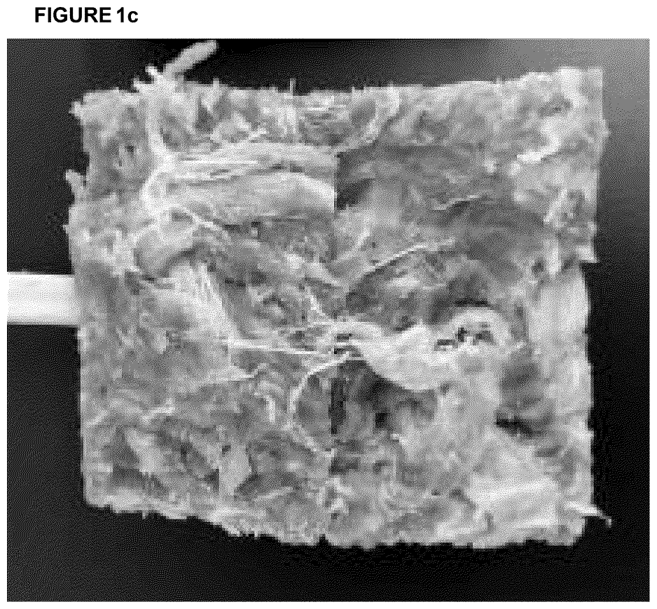

FIGS. 1a and 1b contain images of the TVP pieces before and after the shredding treatment. The TVP pieces obtained after shredding had an average Circularity (n=30) of 0.15.

Next, all dry powder ingredients except the gluten powder were mixed in a Kenwood mixer. The hydrated TVP was admixed for 1 min at speed 1. Vinegar and the balance of water were admixed for 1 min at speed 1. The sunflower oil was admixed for 1 min at speed 1. Finally, the gluten powder was admixed for 2 min at speed 2.

The dough so obtained was cooked in a steam oven at 90° C. with 100% steam, until a core temperature was reached of 85° C. After cooking, the meat analogue was cooled down until a core temperature of <8 C° was achieved. Next, the chilled meat analogue was cut into chunks.

The chunks of meat analogue were prepared for sensory evaluation by sous-vide method. This included cooking in a cooking bag at 90° C. for 15 minutes. FIG. 1c shows an image of a cooked chunk.

The meat analogue so prepared were evaluated by an expert panel (blind testing). The meat analogue was found to closely resemble stewed meat regarding visual resemblance (+++) and sensory attributes including, fibrosity, firmness, chewiness and overall meat resemblance (+++).

### Example 2

A meat analogue according to the invention (Example 2) was prepared as follows: 33.6 wt. % of hydrated pieces TVP was provided by hydrating 10.5 wt. % of dry TVP (Unitex S-2010, Vitablend NL) with 23.1 wt. % of water. Said TVP comprised at least 30 wt. % of elongated pieces having a Circularity of less than 0.30.

The hydrated TVP pieces were mixed with 4.35 wt. % of spices, flavouring and colouring, 0.4 wt. % carrageenan (Welco gelform 1263), 4.5 wt. % Soy protein Isolate (Supro EX37 HG-IP Du Pont) in a Kenwood mixer at speed 1 for 1 min. 29.45 wt. % water and 0.7 wt. % vinegar were admixed for 1 minute (speed 1) followed by admixing 6 wt. % of sunflower oil (1 min at speed 1) and finally 21 wt. % Vital Wheat Gluten (200) was admixed at speed 2 for 2 minutes to obtain a meat analogue dough. The meat analogue dough was heated in a steam oven at 90° C. with 100% steam, until a core temperature was reached of 85° C. After cooking, the meat analogue was cooled down until a core temperature of <8 C° was achieved.

### Example 3

A meat analogue according to the invention was prepared as in Example 2 except that the TVP used was Unitex 2030 (Vitablend NL), said TVP having elongated pieces having a Circularity of less than 0.30 and a maximum Feret diameter of 20-80 mm.

### Example 4

A meat analogue according to the invention was prepared as in Example 2 except that the TVP used S-Fibertex 2265. This TVP was hydrated and shredded as described in Example 1 to provide elongated pieces having a circularity of 0.15 and a maximum Feret diameter of 25-60 mm.

### Sensory Results

The meat analogues according to the invention were examined by 7-9 panellists. The chilled meat analogues were cut into chunks of at least 5 g and the chunks of meat analogue were prepared for sensory evaluation by sous-vide method. This included cooking in a cooking bag at 90° C. for 15 minutes.

The samples were coded (blind testing) and assessed on visual appearance and a number of sensory attributes including, fibrosity, firmness, chewiness and overall meat resemblance with a real meat stew product as reference. In addition, comparative experiments A and B were included in the sensory evaluation:

### Comparative Example A (Gluten Only)

A comparative meat analogue was prepared as in Example 2 except that no TVP was used. Instead, the meat analogue contained 35 wt. % Vital Wheat Gluten (balance water). The resulting chunks of meat analogue did not have the appearance of stewed meat texture at all.

### Comparative Example B

A comparative meat analogue B was prepared as in Example 2 except that a different TVP was used (Response 4380) having a Circularity of at least 0.6. The resulting chunks of meat analogue did not have the appearance of stewed meat texture but showed a granular inhomogeneous structure.

| | Comp A | Comp B | 2 | 3 | 4 |
|---|---|---|---|---|---|
| Visual | −− | − | + | +++ | +++ |
| appearance | | | | | |
| Sensory | −− | − | + | ++ | ++ |

1. A process of preparing a meat analogue comprising the steps of
a) providing hydrated pieces of textured vegan protein (TVP), at least 60 wt. % of said hydrated pieces of TVP being elongated pieces, having a maximum Feret diameter of 20-80 mm and preferably a Circularity of less than 0.35;
b) mixing 25-50 parts by weight of said hydrated pieces of TVP with 20-40 parts by weight of water, 12-26 parts by weight of vital gluten and 0-18 parts by weight of fat to form a meat analogue dough;
c) heating the meat analogue dough to a temperature of at least 70° C. to denature the vital gluten and to coagulate the meat analogue dough;
d) cutting the coagulated meat analogue dough into chunks of meat analogue of at least 5 grams.

2. The process according to claim 1, wherein at least 80 wt. % of the hydrated pieces of TVP being elongated pieces having a maximum Feret diameter of 20-80 mm.

3. The process according to claim 1, wherein said elongated pieces have a Circularity of less than 0.32.

4. The process according to claim 1, wherein said elongated pieces have a Circularity of less than 0.25.

5. The process according to claim 1, wherein said elongated pieces have a Circularity of less than 0.08-0.20.

6. The process according to claim 1, wherein the hydrated pieces of TVP have a water content of 60-82 wt. %.

7. The process according to claim 1, wherein in step b) the amount of fat is mixed such that the meat analogue comprises 5 to 25 wt. % fat calculated by weight of dry matter of the meat analogue.

8. The process according to claim 1, wherein in step b) carrageenan is mixed such that the meat analogue comprises 0.1 to 2 wt. % of carrageenan by weight of the total meat analogue, preferably kappa carrageenan.

9. The process according to claim 1, wherein pieces of TVP and gluten are preferably contained in the meat analogue of the present invention in a dry weight ratio (w/w) of 0.3 to 2, preferably of 0.3 to 1.1, more preferably in a dry weight ratio (w/w) of 0.35 to 0.9.

10. The process according to claim 1, wherein the cut meat analogue is stewed meat analogue, preferably combined with gravy or a sauce in a container followed by sealing of the container.

11. A meat analogue obtainable by a process according to any one of the preceding claims comprising, calculated by weight of dry matter:
(a) 15-45 wt. %, preferably 15-35 wt. % of pieces of texturized vegan protein (TVP);
(b) 20-55 wt. % of gluten;
(c) 0-40 wt. % of fat;
wherein the combination of components (a), (b) and (c) constitutes at least 65 wt. % of the dry matter that is contained in the meat analogue; and
wherein at least 60 wt. % of the pieces of TVP in the meat analogue are elongated pieces having a maximum Feret diameter of 20-80 mm and preferably a Circularity of less than 0.35.

12. The m eat analogue according to claim 11, wherein the meat analogue is a stewed meat analogue.

13. The m eat analogue according to claim 11, wherein the meat analogue comprises, calculated by weight of dry matter, 15-30 wt. % of pieces of TVP.

14. The m eat analogue according to claim 11, wherein the meat analogue comprises, calculated by weight of dry matter, 22-50 wt. % of gluten.

15. A method of preparing a food product, said method comprising:
combining a meat analogue according to any one of the preceding claims with a gravy or a sauce in a container; and
sealing the container.
